(19) United States
(12) Patent Application Publication
(10) Pub. No.: US 2018/0281247 A1
(43) Pub. Date: Oct. 4, 2018

(54) MANUFACTURING METHOD OF MOLDED PRODUCT, MOLDED PRODUCT, AND PRINTER

(71) Applicant: CANON KABUSHIKI KAISHA, Tokyo (JP)

(72) Inventor: Koki Kodaira, Yorktown, VA (US)

(21) Appl. No.: 15/933,233

(22) Filed: Mar. 22, 2018

(30) Foreign Application Priority Data
Mar. 31, 2017 (JP) 2017-072544

(51) Int. Cl. B29C 45/00; B29C 45/28

(52) U.S. Cl. CPC B29C 45/0025; B29L 2031/767; B29C 2045/0027; B29C 45/2806

(57) ABSTRACT

Injecting a resin from a hot runner connected to a recessed shape into a space surrounded by a surface having a shape of a transferred outer surface, a surface having a shape of a transferred non-outer surface that opposes the surface having the shape of the transferred outer surface, and the recessed shape that is recessed with respect to the surface having the shape of the transferred non-outer surface, advancing a valve pin to a position away from the non-outer surface by a distance in a range of 50% to 150%, inclusive, of a basic wall thickness of the recessed shape.

### BACKGROUND

### Field of the Disclosure

The present disclosure relates to a manufacturing method of a resin molded product including an outer surface, to a resin molded product, and to a printer.

### Description of the Related Art

Hitherto, widely known and used is an injection molding method in which a melted resin material is injected into a cavity provided in a mold formed in a desired shape in advance, and in which, after cooling and solidifying the resin inside the mold, opening the mold and taking out the molded product. Furthermore, the product shape portion of the molded product exerting the product function, and a pouring gate (a nozzle portion) of the molding apparatus that injects the molten resin inside the mold are, typically, connected to each other with portions called a sprue, a runner, and a gate. In a typically used side gate mold, the product shape portion, the gate, the runner, and the sprue are taken out in an integral state from the mold with an ejector. Since the above sprue, runner, and gate do not contribute to the function of the product and are unneeded portions, the sprue, the runner, and the gate are cut off and become waste materials leading to increase in cost.

Accordingly, as disclosed in Japanese Patent Laid-Open No. 6-339951, for example, a hot runner method that renders the sprue and the runner unneeded is proposed and is in practical use. A direct gate injection molding method, in which the gate of the hot runner is directly set on the molded product that is to be the product, has an advantage in that, in addition to no waste material being created, the gate does not need to be cut off.

However, in the hot runner method disclosed in Japanese Patent Laid-Open No. 6-339951, a gate that is to be a gateway for injecting a resin is disposed in a cavity that is a space for forming the molded product provided inside a mold. Furthermore, a method of closing the gate with a valve pin after the injection of the resin is employed. In other words, the heated valve pin of the hot runner comes in direct contact with the resin injected in the cavity.

For example, work is put into the design of an envelope of a printer, such as having the outer surface that is seen by people having a glossy surface, and the thickness of the envelope is becoming thinner to reduce the weight thereof. If the gate is provided on a surface having a shape of the transferred non-outer surface on the back side of the surface having the shape of the transferred outer surface seen by people, the heated valve pin of hot runner will come in contact with the resin injected in the cavity, and there will be an adverse effect on the outer surface to which work has been put into its design.

Specifically, by setting the temperature of the mold lower than the resin temperature, the resin being injected inside the cavity is cooled and solidified while the surface shape formed on the cavity is transferred to the resin. However, in so doing, the heated valve pin of the hot runner is abutted against the resin that has started to cool and solidify. The heat of the heated valve pin is transferred to the resin that has started to become cooled and solidified (naturally, the resin on the non-outer surface against which the valve pin abuts against as well and the resin on the outer surface of the back side as well), and the solidification of the resin at the peripheral portion of the valve pin is delayed. Meanwhile, the mold that is set at a low temperature continues cooling and solidification of the resin in the portions other than the peripheral portion of the valve pin, and the transfer of the surface shape of the cavity is performed according to the transfer condition determined by the mold temperature. Accordingly, there will be portions that are formed by different resin transfer conditions in the outer surface of the molded product that is formed by solidifying resin inside the cavity. The above forms a non-uniform portion on the outer surface and affects the appearance of the molded product.

### SUMMARY

In order to overcome existing problems, the present disclosure provides a manufacturing method for a molded product capable of obtaining a high-quality appearance even when a method for forming a molded product that disposes a gate of the hot runner directly on the molded product is employed.

A method for manufacturing a molded product according to an aspect of the present disclosure, the molded product including an outer surface and a non-outer surface on a back side of the outer surface, the method for manufacturing including injecting a resin from a hot runner connected to a recessed shape into a space surrounded by a surface having a shape of a transferred outer surface, a surface having a shape of a transferred non-outer surface that opposes the surface having the shape of the transferred outer surface, and the recessed shape that is recessed with respect to the surface having the shape of the transferred non-outer surface, and advancing a valve pin to a position away from the non-outer surface by a distance in a range of 50% to 150%, inclusive, of a basic wall thickness of the recessed shape.

A molded product according to an aspect of the present disclosure includes an outer surface, a non-outer surface on a back side of the outer surface, and a protruded shape on the non-outer surface, the protruded shape including a side surface and an upper surface, in which a maximum length and a minimum length of the upper surface are in a range of 100% to 150%, inclusive, of a basic wall thickness.

A printer including the molded product including an outer surface, a non-outer surface on a back side of the outer surface, and a protruded shape on the non-outer surface, the protruded shape including a side surface and an upper surface, wherein a maximum length and a minimum length of the upper surface are in a range of 100% to 150%, inclusive, of a basic wall thickness.

Further features of the present disclosure will become apparent from the following description of exemplary embodiments with reference to the attached drawings.

### BRIEF DESCRIPTION OF THE DRAWINGS

FIGS. 1A to 1C are drawings illustrating a representative exemplary embodiment of a manufacturing method of a molded product of the present disclosure.

FIG. 2 illustrates an example of the molded product manufactured by the manufacturing method of the molded product of the present disclosure.

FIGS. 3A to 3E are diagrams illustrating examples of a protruded shape of the molded product of the present disclosure.

FIG. 4 is a diagram illustrating another exemplary embodiment of the present disclosure.

FIG. 5 is a diagram illustrating a manufacturing method of a conventional molded product, according to the present disclosure.

### DESCRIPTION OF THE EMBODIMENTS

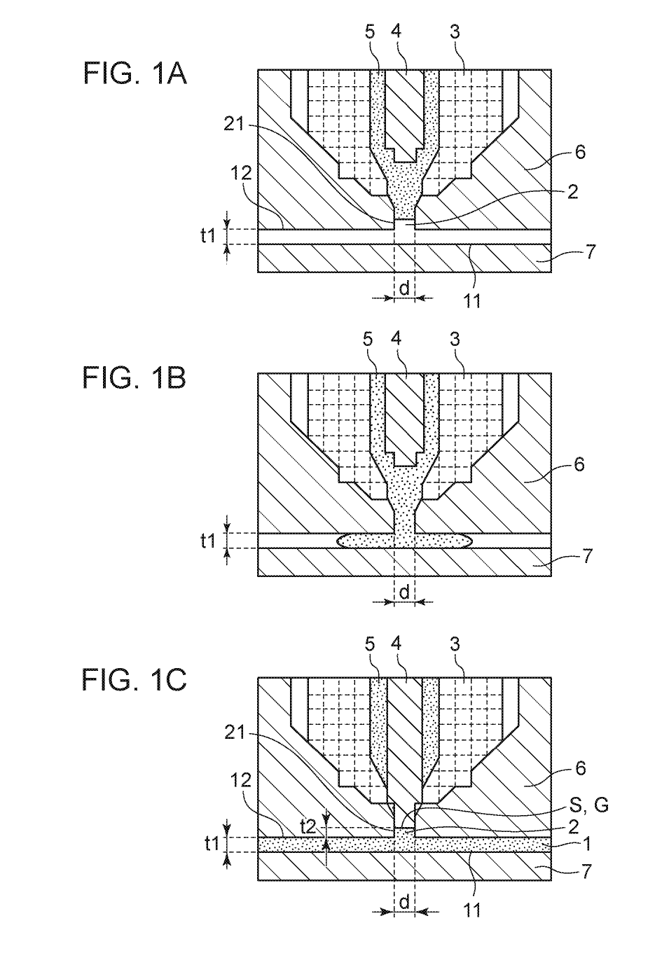

FIGS. 1A to 1C are drawings illustrating a representative exemplary embodiment of a manufacturing method of a molded product of the present disclosure. FIGS. 1A to 1C are cross-sectional views of a portion of a mold, in which FIG. 1A is a drawing illustrating a state before a resin is injected, FIG. 1B is a drawing illustrating a state in which the resin is being injected, and FIG. 1C is a drawing illustrating a state in which the resin after being injected is being cooled and solidified, and in which a gate has been closed by a valve pin.

In FIGS. 1A to 1C, reference numeral 1 is a cavity that is a space for forming the molded product. In the present exemplary embodiment, a surface 11 having a shape of a transferred outer surface is formed on a lower side of the cavity 1, and a surface 12 having a shape of a transferred non-outer surface is formed on an upper side of the cavity 1. In other words, the surface including the shape of the transferred outer surface and the surface including the shape of the transferred non-outer surface are formed so as to oppose each other. Reference numeral 2 is a recessed shape that forms a portion of the cavity 1 and that is recessed with respect to the non-outer surface 12. The recessed shape 2 has a cylindrical shape surrounded by a side surface 21. While the recessed shape 2 is, as an example, described as having a cylindrical space in the present example embodiment, the recessed shape 2 is not limited to a cylindrical space, and the upper surface thereof may have a square shape, a polygonal shape, an elliptical shape, or the like. Reference numeral 3 is a hot runner that supplies resin to the cavity 1. The hot runner 3 is connected to the recessed shape 2. Resin is supplied to the hot runner 3 from an injection unit (not shown) abutted against the mold. Reference numeral 5 is a flow path of the resin inside the hot runner 3. Reference numeral 4 is a valve pin that is mounted in the hot runner 3 and that seals a gate that is a gateway of the resin into the cavity 1. A distal end surface S of the valve pin 4 has a shape of the transferred upper surface of the recessed shape 2. Reference numeral 6 is a first mold (a fixed mold) and, in the present exemplary embodiment, includes the surface 12 having the shape of the transferred non-outer surface and the hot runner 3. Reference numeral 7 is a second mold (a movable mold) and, in the present exemplary embodiment, includes the surface 11 having the shape of the transferred outer surface. Reference sign G indicates the gate. Since the gate G is an injection hole of the resin into the cavity, in the present exemplary embodiment, the gate is defined as a surface that is positioned at the distal end surface S of the valve pin 4 in FIG. 1C when the valve pin 4 is in a closed state. Furthermore, a mark of the valve pin 4 transferred to the upper surface of the recessed shape 2 with the distal end surface S of the valve pin 4 may be referred to as a gate mark. Furthermore, in the present exemplary embodiment, the outer surface may be referred to as a first surface, and the non-outer surface may be referred to as a second surface.

An exemplary embodiment of a manufacturing method of the molded product of the present disclosure will be described next.

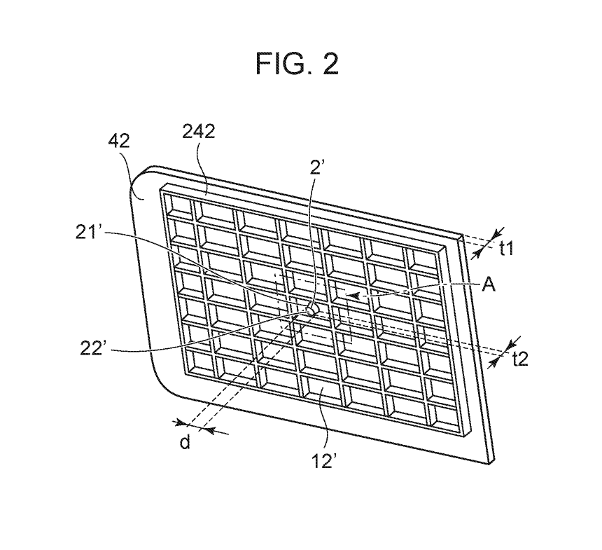

FIG. 1A illustrates a state in which the valve pin 4 is retracted and the gate G is open. The resin is injected into the cavity 1 through the gate G in the above state. FIG. 1B a state in which the resin is being injected. Subsequently, after the injection of the resin into the cavity 1 is completed, the valve pin 4 is advanced, and the gate G is closed. FIG. 1C depicts such a state. Furthermore, a molded product illustrated in FIG. 2, for example, is manufactured.

The resin is injected into the cavity 1 through the recessed shape 2 surrounded by the recessed side surface 21 and, subsequently, the distal end surface S of the valve pin 4 advances and forms the upper surface of the recessed shape 2. Subsequently, the molded product including an outer surface 11′ to which the shape of the transferred outer surface has been transferred, a non-outer surface 12′ to which the shape of the transferred non-outer surface has been transferred, and a protruded shape 2′ to which the recessed shape has been transferred. In other words, the cavity 1 is a space surrounded by the surface 11 having the shape of the transferred outer surface, the surface 12 having the shape of the transferred non-outer surface, and the recessed side surface 21. After the resin is filled into the above space, an upper surface 22′ of the protruded shape 2′, to which the recessed shape 2 has been transferred to the resin with the distal end surface S of the valve pin 4, is formed. In the present exemplary embodiment, a case in which the shape of the upper surface 22′ of the protruded shape 2′ is the same as the shape of the distal end surface S of the valve pin 4 (or that do not have much differences in the shapes thereof) is described. However, the present disclosure is not limited to the above configuration. For example, the upper surface 22′ of the protruded shape 2′ may be smaller or larger than the distal end surface S of the valve pin 4. For example, in a case in which the distal end surface S of the valve pin 4 is smaller, the upper surface (a bottom surface) forming the cavity 1 will be partially formed by the distal end surface S of the valve pin 4 and the other portions will be formed by the first mold.

Reference sign t1 is a basic wall thickness of the molded product that is manufactured by injecting and solidifying the resin in the cavity 1. The wall thickness is the thickness (the distance) between the outer surface and the non-outer surface of the molded product, and in a molded product formed by injection molding, in a case in which the wall thickness of the molded product is locally thick, a dent referred to as a sink mark is created in the surface of the molded product. Accordingly, it is a basic of a molded product formed by injection molding to design the wall thickness to be as uniform as possible to the extent the product requirements, such as the structure, allow. The basic wall thickness t1 of the present exemplary embodiment refers to a wall thickness of the molded product manufactured in the present exemplary embodiment that is as uniform as possible to the extent the product requirement, such as the structure, allows. Specifically, in the molded product manufactured in the present exemplary embodiment, the basic wall thickness t1 is the wall thickness that has the largest surface area among the wall thicknesses obtained by, after determining random 50 mm by 50 mm measuring areas, measuring the wall thicknesses in the measuring areas and acquiring the surface areas of the measuring areas. In the present exemplary embodiment, the basic wall thickness t1 is desirably 3.5 mm or less. A noticeable effect of the present disclosure is exerted when the wall thickness is 3.5 mm or less. A height t2 is the height of the molded product from the upper surface 22′ of the protruded shape 2′ to the non-outer surface. Reference sign d is a diameter of a round-shaped upper surface when the protruded shape 2′ is cylindrical. In a case in which the upper surface 22′ of the protruded shape 2′ is not a round shape, d is the maximum length of the upper surface 22′ of the protruded shape 2′, and d′ is the minimum length of the upper surface 22′ of the protruded shape 2′. The cavity is fabricated by processing the first mold and the second mold so that the basic wall thickness t1, the height t2 of the protruded shape 2′, and the maximum length d (the minimum length d′) of the shape of the upper surface 22′ of the protruded shape 2′ of the molded product are formed to have the desired values. Subsequently, the resin is injected into the cavity through the injection unit, the hot runner, and the gate G.

By having the temperature of the mold (specifically, controlled within a range between 20 degrees to 70 degrees, inclusive) be set lower than the resin temperature, the resin that has been injected inside the cavity is cooled and solidified while the surface shape formed in the cavity is transferred thereto. After the injection of the resin into the cavity 1 is completed, the gate G is closed by advancing the valve pin 4. In other words, the heated valve pin 4 of the hot runner 3 abuts against the resin in which cooling and solidification has started. If the recessed shape 2 (the protruded shape 2′ in the molded product) is not provided, the valve pin 4 will directly abut against the portion forming the basic wall thickness t1. In other words, heat is transferred from the heated valve pin 4 to the resin that has started to become cooled and solidified, and is, naturally, not only transferred to the non-outer surface against which the valve pin 4 abuts, but also to the outer surface on the back side since the basic wall thickness t1 is, for example, 3.5 mm or smaller. Accordingly, solidification is delayed. Meanwhile, the mold that is set at a low temperature furthers the cooling and solidification of the resin in the portions other than the peripheral portion of the valve pin 4, and the transfer of the surface shape of the cavity 1 is performed according to the transfer condition determined by the mold temperature. Accordingly, since there will be portions that are formed by different resin transfer conditions in the outer surface of the molded product that is formed by solidifying resin inside the cavity 1, an ununiform portion affecting the appearance of the molded product is formed on the outer surface. Accordingly, the recessed shape 2 (the protruded shape 2′ in the molded product) is provided. By providing the protruded shape 2′ in the molded product, the valve pin 4 abutting against the protruded shape 2′ forms the upper surface 22′. Since the protruded shape 2′ is surrounded by the mold set at a temperature that is lower than the resin temperature, the heat from the valve pin 4 is cooled rapidly such that cooling proceeds before the heat reaches the outer surface of the back side; accordingly, the effect of the heat on the outer surface can be suppressed to the extent possible, and occurrence of an appearance defect can be suppressed. In other words, the heat of the valve pin 4 can be blocked by the recessed shape 2 (the protruded shape 2′ in the molded product), and a heat insulation effect can be obtained.

The height t2 of the protruded shape 2′ of the molded product, and the maximum length d (and the minimum length d′) of the shape of the upper surface 22′ of the protruded shape 2′ will be described next.

The height t2 of the protruded shape 2′ of the present exemplary embodiment is preferably in the range of 50% to 150%, inclusive, of the basic wall thickness t1. In other words, the resin is injected into the cavity 1 through the recessed shape 2 surrounded by the recessed side surface 21 and, subsequently, the valve pin 4 is advanced, and the upper surface of the recessed shape 2 is formed by advancing the distal end surface S of the valve pin 4 to a position that is away from the non-outer surface by a distance in the range of 50% to 150%, inclusive, of the basic wall thickness t1. If the height t2 is under 50% of the basic wall thickness t1, while there is a little heat insulation effect with the protruded shape 2′, a sufficient heat insulation effect cannot be obtained. Accordingly, the resin cooling conditions between the portion of the outer surface of the back side where the valve pin 4 abuts against and the other portions of the outer surface of the back side become different such that there will be cases in which an appearance defect occurs in the resin molded product. Furthermore, if the height t2 is over 150% of the basic wall thickness t1, there will be too much pressure loss when the resin is filled; accordingly, there will be cases in which transferability becomes poor. Accordingly, the height t2 is preferably in the range of 50% to 150%, inclusive, of the basic wall thickness t1.

Furthermore, the maximum length d of the shape of the upper surface 22′ of the protruded shape 2′ is preferably in the range of 100% to 150%, inclusive, of the basic wall thickness t1 of the resin molded product. In a case in which the maximum length d and the minimum length d′ of the shape of the upper surface 22′ of the protruded shape 2′ are different, the maximum length d and the minimum length d′ are both preferably in the range of 100% to 150%, inclusive, of the basic wall thickness t1 of the resin molded product. If the maximum length d (and the minimum length d′) is under 100% of the basic wall thickness t1 of the resin molded product, there will be too much pressure loss when the resin is filled, and sufficient transfer of the resin cannot be performed; accordingly, there will be cases in which an appearance defect occurs. If the maximum length d is over 150% of the basic wall thickness t1 of the resin molded product, the thickness of the protruded shape becomes excessively thicker than the basic wall thickness t1; accordingly, the inside of the protruded shape cannot be cooled, and the cooling of the protruded shape 2 becomes delayed with respect to the cooling of the resin molded product. In the above state, there are cases in which a sink mark is formed on the outer surface of the back side of the resin molded product where the valve pin 4 abuts against and in which a different appearance defect occurs. Accordingly, the maximum length d (and the minimum length d′) is preferably in the range of 100% to 150%, inclusive, of the basic wall thickness t1.

Exemplary embodiments of the molded product manufactured by the above manufacturing method of the molded product will be described next.

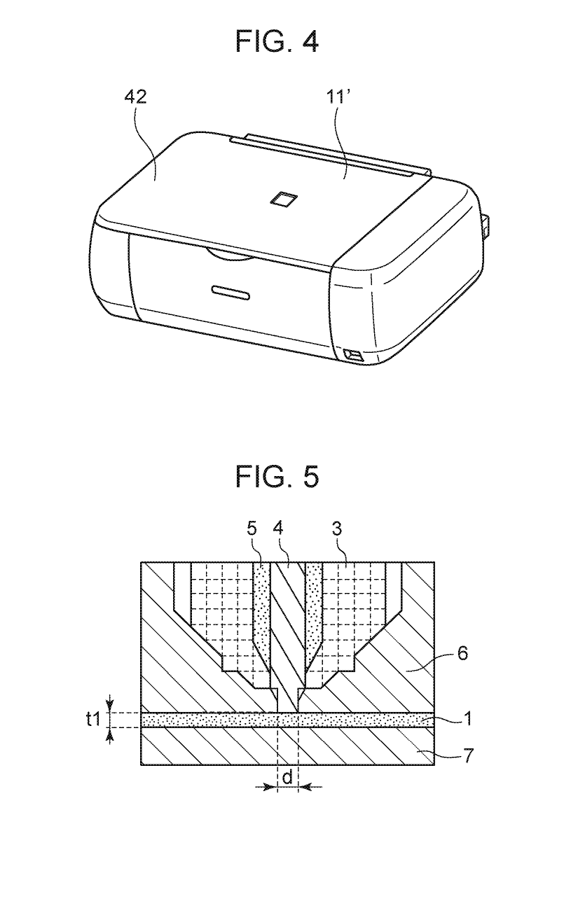

FIG. 2 illustrates a molded product 42 of a printer illustrated in FIG. 4. In FIG. 2, reference numeral 12′ denotes the non-outer surface of the molded product 42. The non-outer surface 12′ includes the cylindrically-protruded protruded shape 2′ that includes the side surface 21′ and the upper surface 22′. Furthermore, the maximum length and the minimum length (the maximum length and the minimum length are the same in the present exemplary embodiment) of the upper surface 22′ of the protruded shape 2′ are in the range of 100% to 150%, inclusive, of the basic wall thickness t1. Furthermore, the height t2 of the protruded shape 2′ is preferably in the range of 50% to 150%, inclusive, of the basic wall thickness t1. While an example in which ribs 24 are formed on the non-outer surface are described in the present exemplary embodiment, the ribs 24 do not have to be formed on the non-outer surface.

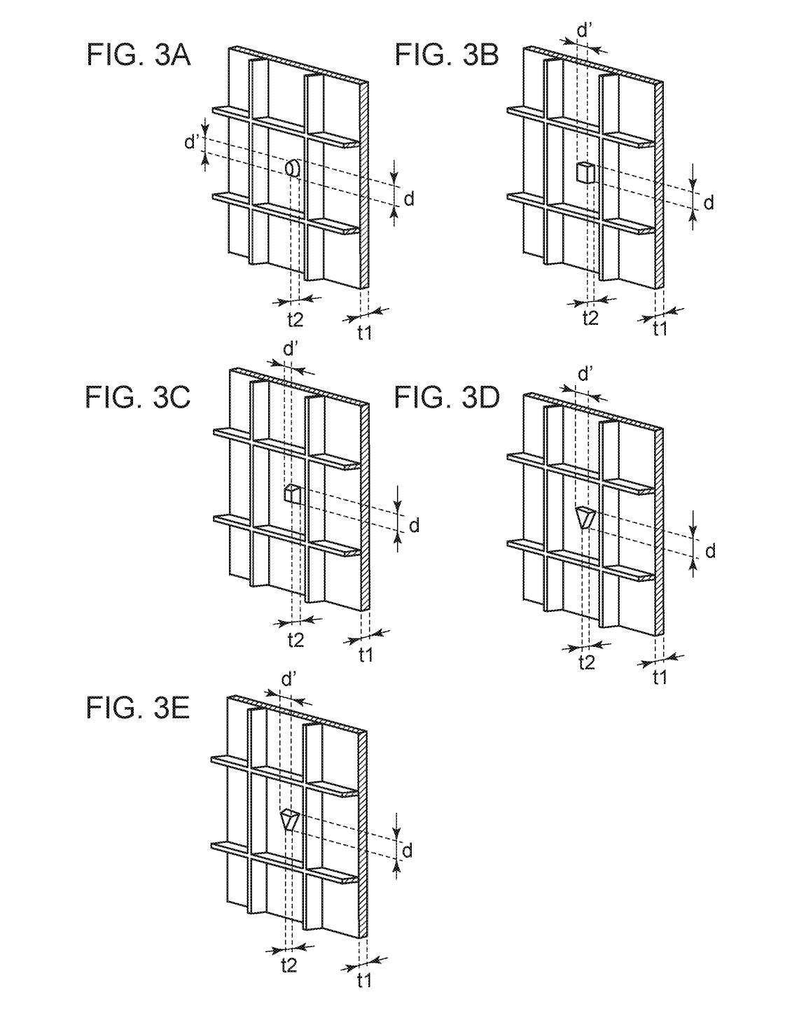

FIGS. 3A to 3E are diagrams illustrating another exemplary embodiment of the shape of the protruded shape 2′, and are schematic views of area A in FIG. 2 illustrated in an enlarged manner. Portions that have the same function as the portions in FIG. 2 will be attached with the same reference numeral, and description thereof will be omitted. FIG. 3A illustrates an example in which the shape of the protruded shape 2′ is a truncated cone shape. Furthermore, FIG. 3B illustrates an example in which the shape of the protruded shape 2′ is quadrangular cylindrical shape. FIG. 3C illustrates a case in which the shape of the protruded shape 2′ is a truncated square pyramid shape. FIG. 3D illustrates a case in which the shape of the protruded shape 2′ is a triangular cylindrical shape. FIG. 3E illustrates a case in which the shape of the protruded shape 2′ is a truncated triangular pyramid shape. While the main exemplary embodiments are illustrated in FIGS. 3A to 3E, not limited to the exemplary embodiments, various shapes such as a pentagonal cylindrical shape and a truncated pentagonal pyramid shape can be conceived; however, as the shapes become complex, the processing thereof becomes more difficult and cost increases.

For example, work is put in to the design of an envelope of a printer, such as having the outer surface that is seen by people have a glossy surface, and the thickness of the envelope is becoming thinner to reduce the weight thereof. Accordingly, a noticeable effect of the present disclosure can be exerted by applying the present exemplary embodiments to envelopes of printers.

### EXAMPLES

Examples will be described next.

### First Example

Using an injection molding apparatus (not shown), a PC/ABS resin melted by setting the injection molding apparatus at a resin melting temperature and the hot runner at a temperature of 260° C. was ejected. The mold temperature was 50° C. The wall thickness t1 of the wall of the molded product was 1.0 mm, and the protruded shape was cylindrical. Furthermore, the height t2 of the protruded shape was 0.3 mm, 0.5 mm, 1.0 mm, 1.5 mm, 1.7 mm, or 2.0 mm. Furthermore, the diameter d of the protruded shape 2 was 0.7 mm, 1.0 mm, 1.2 mm, 1.5 mm, or 2.0 mm. Evaluation was conducted on the molded products formed by combining the heights and the diameters described above. A comparative example of the molded product having the wall thickness t1 of 1.0 mm, and the protruded shape height t2 of 0 mm was evaluated. The results are shown in Table 1. GOOD in the table indicates a state in which the molded product had no interfaces whatsoever and had no problem as a qualified product. ACCEPTABLE indicates a state in which, while there was a slightly discolored portion, the molded product had no problem as a qualified product. POOR indicates a state in which the molded product clearly had an interface, and the molded product could not be used as a qualified product. Reference sign S indicates that there was a filling failure and that the molded product could not be used as a qualified product. Reference sign H indicates that there was a sink mark, and that the molded product could not be used as a qualified product.

TABLE 1

| | | Height of Protruded Shape t2 (mm) | | | | | | |
|---|---|---|---|---|---|---|---|---|
| | | Comparative | | | | | | |
| | | Example | | | | | | |
| | | 0 | 0.3 | 0.5 | 1.0 | 1.5 | 1.7 | 2.0 |
| Diameter | 0.7 | POOR | S | S | S | S | S | S |
| (mm) | 1.0 | POOR | ACCEPTABLE | GOOD | GOOD | GOOD | ACCEPTABLE | ACCEPTABLE |
| | 1.2 | POOR | ACCEPTABLE | GOOD | GOOD | GOOD | ACCEPTABLE | ACCEPTABLE |
| | 1.5 | POOR | ACCEPTABLE | GOOD | GOOD | GOOD | ACCEPTABLE | ACCEPTABLE |
| | 2.0 | POOR | H | H | H | H | H | H |

### Second Example

Using the injection molding apparatus (not shown), a PC/ABS resin melted by setting the injection molding apparatus at the resin melting temperature and the hot runner at the temperature of 260° C. was ejected. The mold temperature was 50° C. The wall thickness t1 of the wall of the molded product was 1.6 mm, and the protruded shape was cylindrical. Furthermore, the height t2 of the protruded shape was 0.5 mm, 0.8 mm, 1.6 mm, 2.4 mm, 2.7 mm, or 3.0 mm. Furthermore, the diameter d of the protruded shape 2 was 1.0 mm, 1.6 mm, 2.0 mm, 2.4 mm, or 3.0 mm. Evaluation was conducted on the molded products formed by combining the heights and the diameters described above. A comparative example of the molded product having the wall thickness t1 of 1.6 mm, and the protruded shape height t2 of 0 mm was evaluated. The results are shown in Table 2. GOOD in the table indicates a state in which the molded product had no interfaces whatsoever and had no problem as a qualified product. ACCEPTABLE indicates a state in which, while there was a slightly discolored portion, the molded product had no problem as a qualified product. POOR indicates a state in which the molded product clearly had an interface, and the molded product could not be used as a qualified product. Reference sign S indicates that there was a filling failure and that the molded product could not be used as a qualified product. Reference sign H indicates that there was a sink mark, and that the molded product could not be used as a qualified product.

TABLE 2

| | | Height of Protruded Shape t2 (mm) | | | | | | |
|---|---|---|---|---|---|---|---|---|
| | | Comparative | | | | | | |
| | | Example | | | | | | |
| | | 0 | 0.5 | 0.8 | 1.6 | 2.4 | 2.7 | 3.0 |
| Diameter | 1.0 | POOR | S | S | S | S | S | S |
| (mm) | 1.6 | POOR | ACCEPTABLE | GOOD | GOOD | GOOD | ACCEPTABLE | ACCEPTABLE |
| | 2.0 | POOR | ACCEPTABLE | GOOD | GOOD | GOOD | ACCEPTABLE | ACCEPTABLE |
| | 2.4 | POOR | ACCEPTABLE | GOOD | GOOD | GOOD | ACCEPTABLE | ACCEPTABLE |
| | 3.0 | POOR | H | H | H | H | H | H |

### Third Example

Using the injection molding apparatus (not shown), a PC/ABS resin melted by setting the injection molding apparatus at the resin melting temperature and the hot runner at the temperature of 260° C. was ejected. The mold temperature was 50° C. The wall thickness t1 of the wall of the molded product was 2.0 mm, and the protruded shape was cylindrical. Furthermore, the height t2 of the protruded shape was 0.8 mm, 1.0 mm, 2.0 mm, 3.0 mm, 3.5 mm, or 4.0 mm. Furthermore, the diameter d of the protruded shape 2 was 1.0 mm, 2.0 mm, 2.5 mm, 3.0 mm, or 3.5 mm. Evaluation was conducted on the molded products formed by combining the heights and the diameters described above. A comparative example of the molded product having the wall thickness t1 of 2.0 mm, and the protruded shape height t2 of 0 mm was evaluated. The results are shown in Table 3. GOOD in the table indicates a state in which the molded product had no interfaces whatsoever and had no problem as a qualified product. ACCEPTABLE indicates a state in which, while there was a slightly discolored portion, the molded product had no problem as a qualified product. POOR indicates a state in which the molded product clearly had an interface, and the molded product could not be used as a qualified product. Reference sign S indicates that there was a filling failure and that the molded product could not be used as a qualified product. Reference sign H indicates that there was a sink mark, and that the molded product could not be used as a qualified product.

TABLE 3

| | | Height of Protruded Shape t2 (mm) | | | | | | |
|---|---|---|---|---|---|---|---|---|
| | | Comparative | | | | | | |
| | | Example | | | | | | |
| | | 0 | 0.8 | 1.0 | 2.0 | 3.0 | 3.5 | 4.0 |
| Diameter | 1.0 | POOR | S | S | S | S | S | S |
| (mm) | 2.0 | POOR | ACCEPTABLE | GOOD | GOOD | GOOD | ACCEPTABLE | ACCEPTABLE |
| | 2.5 | POOR | ACCEPTABLE | GOOD | GOOD | GOOD | ACCEPTABLE | ACCEPTABLE |
| | 3.0 | POOR | ACCEPTABLE | GOOD | GOOD | GOOD | ACCEPTABLE | ACCEPTABLE |
| | 3.5 | POOR | H | H | H | H | H | H |

The present disclosure using a valve pin type hot runner that does not use a cold runner that generates waste material is capable of inexpensively manufacturing a molded product that has a satisfactory outer surface by adding a protruded shape on a non-outer surface.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-072544 filed Mar. 31, 2017, which is hereby incorporated by reference herein in its entirety.

What is claimed is:

1. A method for manufacturing a molded product including an outer surface and a non-outer surface on a back side of the outer surface, the method for manufacturing comprising:
injecting a resin from a hot runner connected to a recessed shape into a space surrounded by a surface having a shape of a transferred outer surface, a surface having a shape of a transferred non-outer surface that opposes the surface having the shape of the transferred outer surface, and the recessed shape that is recessed with respect to the surface having the shape of the transferred non-outer surface, and
advancing a valve pin to a position away from the non-outer surface by a distance in a range of 50% to 150%, inclusive, of a basic wall thickness of the recessed shape.

2. The manufacturing method of a molded product according to claim 1,
wherein the basic wall thickness is 3.5 mm or less.

3. The manufacturing method of a molded product according to claim 1,
wherein an upper surface of a protruded shape that is a shape of the recessed shape transferred to the resin has a maximum length and a minimum length in a range of 100% to 150%, inclusive, of the basic wall thickness.

4. The manufacturing method of a molded product according to claim 1,
wherein a shape of the resin to which the recessed shape has been transferred is cylindrical.

5. A resin molded product comprising:
an outer surface;
a non-outer surface on a back side of the outer surface; and
a protruded shape on the non-outer surface, the protruded shape including a side surface and an upper surface,
wherein a maximum length and a minimum length of the upper surface are in a range of 100% to 150%, inclusive, of a basic wall thickness.

6. The molded product according to claim 5,
wherein the basic wall thickness is 3.5 mm or less.

7. The molded product according to claim 5,
wherein a height of the protruded shape is in a range of 50% to 150%, inclusive, of the basic wall thickness.

8. The molded product according to claim 5,
wherein the protruded shape is cylindrical.

9. A printer comprising:
the molded product including
an outer surface,
a non-outer surface on a back side of the outer surface, and
a protruded shape on the non-outer surface, the protruded shape including a side surface and an upper surface, wherein a maximum length and a minimum length of the upper surface are in a range of 100% to 150%, inclusive, of a basic wall thickness.
